(19) United States
(12) Patent Application Publication
(10) Pub. No.: US 2026/0214436 A1
(43) Pub. Date: Jul. 23, 2026

(54) WIRELESS SENSING COMMUNICATION METHOD, APPARATUS, DEVICE AND STORAGE MEDIUM

(71) Applicant: Beijing Xiaomi Mobile Software Co., Ltd., Beijing (CN)

(72) Inventors: Xinli WANG, Beijing (CN); Yang SHEN, Beijing (CN)

(73) Assignee: Beijing Xiaomi Mobile Software Co., Ltd., Beijing (CN)

(21) Appl. No.: 19/144,387

(22) PCT Filed: Dec. 29, 2022
(86) PCT No.: PCT/CN2022/143659

§ 371 Date: Jun. 27, 2025

(51) Int. Cl. H04W 12/02; H04W 4/38

(52) U.S. Cl. CPC H04W 12/02; H04W 4/38

(57) ABSTRACT

A wireless sensing communication system is disclosed for enabling privacy-aware acquisition of parameter information associated with a sensing target. In one embodiment, a core network device receives a sensing request from a sensing request device, wherein the request includes information identifying a target to be sensed. The core network device determines a privacy policy associated with the sensing target, the policy being pre-configured based on the type of target, either a terminal or a non-terminal object, and the corresponding terminal or application. Based on whether the sensing request complies with the determined privacy policy, the core network device selectively executes a sensing procedure to obtain the requested parameter information or, alternatively, generates a failure indication. The sensing result, which may include the acquired parameter data or the failure indication, is transmitted to the requesting device.

### CROSS-REFERENCE TO RELATED APPLICATION

The present application is a National Stage of International Application No. PCT/CN2022/143659, filed on Dec. 29, 2022, the entire disclosure of which is incorporated herein by reference for all purposes.

### TECHNICAL FIELD

The present disclosure relates to the field of communication technology, and in particular to a wireless sensing communication method, apparatus, device, and storage medium.

### BACKGROUND

At present, the purpose of wireless sensing technology is to acquire information about an object and its characteristics without physically contacting the remote object. The sensing data of the object and its surrounding environment can be used for analysis and to acquire meaningful information about the object and its characteristics.

Radar is a widely applied wireless sensing technology that primarily uses radio waves for detection and ranging, such as determining the distance (or range), angle, and instantaneous linear velocity of an object. It can be understood that, radar is a wireless sensing technology based on radio frequency (RF) sensors. Some non-RF sensor wireless sensing technologies are also utilized in their corresponding fields. For example, time of flight (ToF) cameras, accelerometers, and gyroscopes, etc.

Due to the existence of wireless sensing technology, there may be situations where sensing targets do not wish their information to be exposed, such as in private spaces, restricted areas, specific buildings, or certain wireless devices. However, there are currently no protection measures in place to safeguard the privacy of such sensing targets, which increases the risk of privacy leakage.

### SUMMARY

The present disclosure provides a wireless sensing communication method, apparatus, device and storage medium.

According to the first aspect of the embodiment of the present disclosure, a wireless sensing communication method is provided, which is applied to applied to a core network device, and includes: receiving a sensing request sent by a sensing request device, wherein the sensing request is used to acquire parameter information of a sensing target; determining a privacy policy of the sensing target corresponding to the sensing request based on the sensing request, wherein the privacy policy of the sensing target is pre-configured in the core network device; determining a sensing result for the sensing target according to the privacy policy of the sensing target; sending the sensing result to the sensing request device.

According to the second aspect of the embodiment of the present disclosure, a wireless sensing communication method is provided, which is applied to a sensing request device, and includes: sending a sensing request to a core network device, wherein the sensing request is used to acquire parameter information of a sensing target; receiving a sensing result sent by the core network device, wherein the sensing result is determined by the core network device based on the sensing request and in combination with a privacy policy of the sensing target, and the privacy policy of the sensing target is pre-configured in the core network device.

According to the third aspect of the embodiment of the present disclosure, a wireless sensing communication apparatus is provided, the apparatus is configured in a core network device, and the apparatus includes: a receiving module, configured to receive a sensing request sent by a sensing request device, wherein the sensing request is used to acquire parameter information of a sensing target; a processing module, configured to determine a privacy policy of the sensing target corresponding to the sensing request based on the sensing request, wherein the privacy policy of the sensing target is pre-configured in the core network device; wherein the processing module is further configured to determine a sensing result for the sensing target according to the privacy policy of the sensing target; a sending module, configured to send the sensing result to the sensing request device.

According to the fourth aspect of the embodiment of the present disclosure, a wireless sensing communication apparatus is provided, the apparatus is configured in the sensing request device, and the apparatus includes: a sending module, configured to send a sensing request to a core network device, wherein the sensing request is used to acquire parameter information of a sensing target; a receiving module, configured to receive a sensing result sent by the core network device, wherein the sensing result is determined by the core network device based on the sensing request and in combination with a privacy policy of the sensing target, and the privacy policy of the sensing target is pre-configured in the core network device.

According to the fifth aspect of the embodiment of the present disclosure, a wireless sensing communication device is provided, including: a processor; a memory for storing processor executable instructions; wherein the processor is configured to: execute the method of the first aspect and any one of the implementations in the first aspect.

According to the sixth aspect of the embodiment of the present disclosure, a wireless sensing communication device is provided, including: a processor; a memory for storing processor executable instructions; wherein the processor is configured to: execute the methods of the second aspect and any one of the implementations in the second aspect.

According to the seventh aspect of the embodiment of the present disclosure, a non-transitory computer-readable storage medium is provided, when the instructions in the storage medium are executed by the processor of the core network device, the core network device can execute the methods of the first aspect and any one of the implementations in the first aspect.

According to the eighth aspect of the embodiment of the present disclosure, a non-transitory computer-readable storage medium is provided, when the instructions in the storage medium are executed by the processor of the core network device, the core network device can execute the methods of the second aspect and any one of the implementations in the second aspect.

It is to be understood that the foregoing general description and the following detailed description are exemplary and explanatory only and are not restrictive of the present disclosure.

### BRIEF DESCRIPTION OF THE DRAWINGS

The drawings herein are incorporated into the specification and constitute a part of the specification, showing embodiments consistent with the present disclosure, and are used together with the specification to explain the principles of the present disclosure.

FIG. 1 is a schematic diagram of a wireless communication system according to an example embodiment.

FIG. 2 is a flow chart of a wireless sensing communication method according to an example embodiment.

FIG. 3 is a flow chart of a wireless sensing communication method according to another example embodiment.

FIG. 4 is a signaling interaction diagram of a wireless sensing communication method according to an example embodiment.

FIG. 5 is a schematic diagram of a wireless sensing communication apparatus according to an example embodiment.

FIG. 6 is a schematic diagram of a wireless sensing communication apparatus according to another example embodiment.

FIG. 7 is a schematic diagram of a wireless sensing communication device according to an example embodiment.

FIG. 8 is a schematic diagram of a wireless sensing communication device according to another example embodiment.

### DETAILED DESCRIPTION

The example embodiments will be described in detail here, and examples thereof are shown in the accompanying drawings. When the following description refers to the drawings, unless otherwise indicated, the same numbers in different drawings represent the same or similar elements. The implementations described in the following example embodiments do not represent all implementations consistent with the present disclosure.

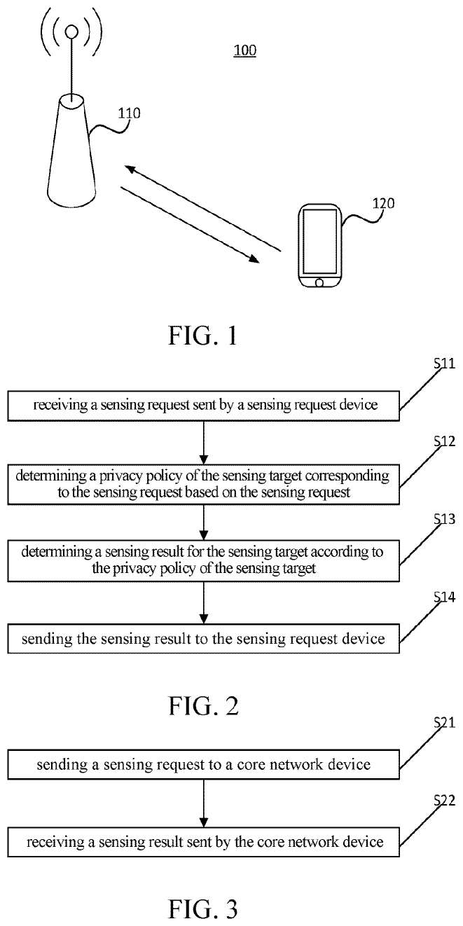

The communication method involved in the present disclosure can be applied to the wireless communication system 100 shown in FIG. 1. The network system may include a network device 110 and a terminal 120. It can be understood that the wireless communication system shown in FIG. 1 is only for schematic illustration, and the wireless communication system may also include other network devices, such as core network devices, wireless relay devices, and wireless backhaul devices, which are not shown in FIG. 1. The embodiment of the present disclosure does not limit the number of network devices and the number of terminals included in the wireless communication system.

It can be further understood that, the wireless communication system of the embodiment of the present disclosure is a network that provides wireless communication functions. The wireless communication system can adopt different communication technologies, such as Code Division Multiple Access (CDMA), Wideband Code Division Multiple Access (WCDMA), Time Division Multiple Access (TDMA), Frequency Division Multiple Access (FDMA), Orthogonal Frequency-Division Multiple Access (OFDMA), Single Carrier FDMA (SC-FDMA), Carrier Sense Multiple Access with Collision Avoidance. According to the capacity, rate, delay and other factors of different networks, the network can be divided into 2G (Generation) network, 3G network, 4G network or future evolution network, such as the 5th Generation Wireless Communication System (5G) network, and the 5G network can also be called New Radio (NR). For the convenience of description, the present disclosure sometimes refers to the wireless communication network as a network.

Further, the network device 110 involved in the present disclosure can also be called a wireless access network device. The wireless access network device may be: a base station, an evolved Node B (eNB), a home base station, an access point (AP) in a wireless fidelity (WIFI) system, a wireless relay node, a wireless backhaul node, a transmission point (TP) or a transmission and receiving point (TRP), etc. It may also be a gNB in an NR system, or it may also be a component or a part of a base station. When it is a vehicle-to-everything (V2X) communication system, the network device may also be a vehicle-mounted device. It should be understood that, in the embodiments of the present disclosure, the specific technology and specific device form adopted by the network device are not limited.

Further, the terminal 120 involved in the present disclosure may also be referred to as a terminal device, a user equipment (UE), a mobile station (MS), a mobile terminal (MT), etc., which is a device that provides voice and/or data connectivity to a user. For example, the terminal may be a handheld device with a wireless connection function, a vehicle-mounted device, etc. At present, some examples of terminals are: Mobile Phones, Pocket Personal Computers (PPCs), handheld computers, Personal Digital Assistants (PDAs), laptop computers, tablet computers, wearable devices, or vehicle-mounted devices, etc. In addition, when it is a vehicle-to-everything (V2X) communication system, the terminal device can also be a vehicle-mounted device. It should be understood that, the embodiments of the present disclosure do not limit the specific technology and specific device form adopted by the terminal.

In the embodiment of the present disclosure, the network device 110 and the terminal 120 can use any feasible wireless communication technology to achieve mutual data transmission. The transmission channel corresponding to the network device 110 sending the data or control information to the terminal 120 is called a downlink channel (DL), and the transmission channel corresponding to the terminal 120 sending the data or control information to the network device 110 is called an uplink channel (UL). It can be understood that, the network device involved in the embodiment of the present disclosure can be a base station. The network device can also be any other possible network devices, and the terminal can be any possible terminal, which is not limited by the present disclosure.

At present, the purpose of wireless sensing technology is to obtain information about objects and their characteristics without physical contact with remote objects. The sensing data of the object and its surrounding environment can be used for analysis, so that meaningful information about the object and its characteristics can be obtained.

Radar is a widely used wireless sensing technology that mainly uses radio for detection and ranging, such as using radio waves to determine the distance (or range), angle, instantaneous linear velocity, etc. of an object. It can be understood that, radar is a wireless sensing technology based on RF sensors. Some non-RF sensor wireless sensing technologies are also included and used in corresponding fields, for example, ToF cameras, accelerometers and gyroscopes, etc.

In the 3rd generation partnership project (3GPP), 5G systems can be used to inherit sensing and communication. That is, sensing capabilities can be provided by the same 5G NR wireless communication system and corresponding infrastructure used for communication. The sensing information can be obtained using RF based and/or non-RF based sensors. In general, this manner can be used in communication-assisted sensing scenarios. For example, a 5G communication system provides sensing services or sensing-assisted information. When sensing information related to a communication channel or environment is used to improve the communication service of the 5G system itself, such sensing information can be used to assist in wireless resource management, interference suppression, beam management, mobility management, etc.

In related technologies, scenarios where 5G systems (5GS) provide communication-assisted sensing services are studied. The 5GS includes base stations and 5G core networks (5G core, 5GC).

For example, in the scenario of real-time environmental monitoring, wireless signals can be used to reconstruct environmental maps, to further improve positioning accuracy. It can be applied to applications (APPs) related to the environment. For example, a large number of real-time monitoring-related applications that may use dynamic three-dimensional (3D) maps, including those for assisted driving, pedestrian flow statistics, intrusion detection, and traffic condition detection, can be realized.

For example, in the scenario of autonomous driving/unmanned aerial vehicle (UAV), the application of autonomous driving/UAV has some common functional requirements. For example, autonomous driving/UAV should support detect and avoid (DAA) to avoid possible obstacles. At the same time, autonomous driving/UAV should have the ability to monitor path information, such as selecting routes and complying with traffic rules.

For example, in the scenario of air pollution detection, the quality of the received wireless signals will show different attenuation characteristics as the air humidity, air particulate matter (PM) concentration, carrier frequency, etc. change. Thus, it can be used for weather or air quality detection.

For example, in the scenario of indoor health care and intrusion detection, breathing rate estimation, breathing depth estimation, apnea detection, elderly vital signs monitoring and indoor intrusion detection can be realized. The intrusion detection means whether there is illegal entry of people or objects in a specific area.

At present, the sensing of wireless communication channels and environment can further improve the performance of communication systems. The scenarios of communication-assisted sensing can be, for example, the following scenarios.
Sense the location and channel environment of the terminal, to narrow the beam scanning range and shorten the beam training time.
Sense the location, speed, movement trajectory and channel environment of the terminal, to perform beam prediction, and reduce the overhead of beam measurement and the delay of beam tracking.
Sense the properties and channel environment of the terminal, to improve the performance of channel estimation.

However, due to the existence of wireless sensing technology, there may be situations where sensing targets do not wish certain information related to them to be exposed, for example, in private spaces, restricted areas, specific buildings, or certain wireless devices. However, there are currently no protection measures in place to safeguard the privacy of such sensing targets, thereby increasing the risk of privacy leakage. How to protect the privacy information of the sensing target is a problem that needs to be solved.

The present disclosure can determine whether to sense the sensitive information of the sensing target through the privacy policy of the sensing target, so as to effectively protect the privacy of the sensing target and improve the security of the wireless sensing system.

FIG. 2 is a flow chart of a wireless sensing communication method according to an example embodiment. As shown in FIG. 2, the method can be applied to a core network device. The core network device can also be called a 5GC network function (NF). The method may include the following steps.

In step S11, a sensing request sent by a sensing request device is received.

In some embodiments, the core network device may receive a sensing request sent by a sensing request device. The sensing request is used to obtain parameter information of a sensing target. The sensing in the present disclosure can also be referred to as perception. The sensing request device can be considered as a device that needs to obtain parameter information of a sensing target. For example, it can be called a sensing request target or a sensing requestor.

For example, the sensing request device can be a terminal, an application server, other core network devices, etc. It can be understood that other core network devices and the core network device that executes the method of FIG. 2 are different 5GC NFs.

For example, if the sensing requestor wants to obtain parameter information of a sensing target, it can send a sensing request to the core network device. The core network device receives the sensing request and learns that the sensing requestor wants to obtain parameter information of the sensing target.

In step S12, a privacy policy of the sensing target corresponding to the sensing request is determined based on the sensing request.

In some embodiments, the core network device may determine the privacy policy of the sensing target corresponding to the sensing request based on the sensing request in S11. The privacy policy of the sensing target may be pre-configured in the core network device.

For example, when the core network device receives the sensing request sent by the sensing requestor, it may query the pre-configured privacy policy. It can be understood that the core network device may be configured with the privacy policy corresponding to at least one sensing target. The core network device may determine, through the sensing request, the parameter information of which sensing target is requested, then determine the privacy policy corresponding to the sensing target.

In step S13, a sensing result for the sensing target is determined according to the privacy policy of the sensing target.

In some embodiments, the core network device may determine the sensing result of the sensing target according to the privacy policy of the sensing target determined in S12.

For example, the core network device may determine whether to execute the corresponding sensing procedure for the sensing target according to the privacy policy of the sensing target, to obtain the sensing result of the sensing target. That is, the core network device determines whether to send the parameter information of the sensing target to the sensing request device, i.e., the sensing requestor.

It can be understood that, the parameter information of the sensing target may include parameter information obtained by real-time monitoring of the sensing target. It may also include parameter information for periodic or non-periodic monitoring. Such parameter information may be configured in the core network device after being monitored, so that when there is a sensing requestor requesting to obtain such parameter information, it can be sent to the sensing requestor.

In some embodiments, the core network device may also determine the sensing result for the sensing target in combination with some protocol regulations or regional regulations.

For example, in some specific places, it is stipulated which sensing targets are allowed to be sensed or prohibited to be sensed. Then, the core network device determines the sensing result for the sensing target according to the protocol regulations or regional regulations, if the privacy policy of the sensing target has not been queried. For another example, if the privacy policy of the sensing target is opposite to the result of the protocol regulations or regional regulations, for example, the privacy policy of the sensing target indicates that the sensing target is allowed to be sensed, while the protocol regulations or regional regulations indicate that the sensing target is prohibited from being sensed; and the privacy policy of the sensing target indicates that the sensing target is prohibited from being sensed, while the protocol regulations or regional regulations indicate that the sensing target is allowed to be sensed, it can be determined whether the sensing target is allowed to be sensed according to preset rules or priorities, which is not limited by this disclosure.

In step S14, the sensing result is sent to the sensing request device.

In some embodiments, the core network device may send the sensing result determined in S13 to the sensing request device. It can be understood that the sensing result is determined according to the privacy policy of the sensing target, for example, it may be parameter information of the sensing target, or it may be indication information for indicating prohibition of obtaining sensing information.

The present disclosure determines whether to sense the sensitive information of the sensing target through the privacy policy of the sensing target, thereby effectively protecting the privacy of the sensing target and improving the security of the wireless sensing system.

In the wireless sensing communication method provided by embodiments of the present disclosure, the sensing target includes a first sensing target and/or a second sensing target, the first sensing target is a first terminal or the first sensing target carries the first terminal, and the second sensing target is a non-terminal or the second sensing target does not carry a terminal. The privacy policy of the sensing target is pre-configured in the core network device through at least one of the following manners: configuring and/or updating a first privacy policy based on the first terminal, wherein the first privacy policy is a privacy policy corresponding to the first sensing target; configuring and/or updating a second privacy policy based on a sensing application of a second terminal, wherein the sensing application of the second terminal is associated with the second sensing target, and the second privacy policy is a privacy policy corresponding to the second sensing target.

In some embodiments, the sensing target may include the first sensing target and/or the second sensing target. The first sensing target can be a first terminal, or the first sensing target carries the first terminal. The second sensing target can be a non-terminal, or the second sensing target does not carry a terminal. It can be understood that the non-terminal means that the second sensing target is not a terminal.

The terminal involved in the present disclosure can be considered to have any possible wireless communication capabilities, such as 3GPP terminal capabilities, WIFI communication capabilities, Bluetooth communication capabilities, ZigBee communication capabilities, etc. For example, the terminal can be a user device that can communicate in a 3GPP network.

In some embodiments, the core network device can configure and/or update the first privacy policy based on the first terminal. The first privacy policy is the privacy policy corresponding to the first sensing target.

It can be understood that, the first sensing target can be a sensing target with 3GPP terminal capabilities. For example, the first sensing target can be a terminal, such as the first terminal. Alternatively, the first sensing target may not have wireless communication capabilities, but the first sensing target can carry a terminal with wireless communication capabilities. For example, the first terminal is configured in the first sensing target. That is, the first sensing target can carry a terminal with 3GPP terminal capabilities, for example, the first sensing target carries the first terminal.

When the first sensing target is the first terminal or the first sensing target carries the first terminal, the core network device configures and/or updates the first privacy policy based on the first terminal.

For example, when the first sensing target is the first terminal or the first sensing target carries the first terminal, the first terminal can communicate directly with the core network device through the wireless communication system, for example, sending the first privacy policy. The core network device can receive and save the first privacy policy. It can be understood that the first privacy policy is used to describe the privacy protection of the first sensing target.

For example, the first terminal sends the first privacy policy to the core network device. The core network device receives and saves the first privacy policy sent by the first terminal. For the case of updating the privacy policy, the core network device can receive a new first privacy policy or a first privacy update policy sent by the first terminal. The core network device overwrites the original first privacy policy based on the received new first privacy policy or the first privacy update policy, to implement the update of the first privacy policy. It can be understood that the update manner is not limited in the present disclosure.

In some embodiments, the second privacy policy is configured and/or updated based on the sensing application of the second terminal. The sensing application of the second terminal is associated with the second sensing target, and the second privacy policy is the privacy policy corresponding to the second sensing target.

It can be understood that the second sensing target may be a sensing target without 3GPP terminal capabilities. For example, some sensing targets may be entities without communication functions, such as buildings, certain specific areas, etc. However, such entities may also be sensed in the wireless sensing scenario. However, these entities may not wish to be sensed due to some special considerations. In some cases, the sensing target without 3GPP terminal capabilities may not carry a terminal with wireless communication capabilities.

The core network device may configure and/or update the second privacy policy based on the sensing application of the second terminal when the second sensing target is a non-terminal or does not carry a terminal.

The sensing application can be installed on the second terminal. That is, the sensing target without 3GPP terminal capabilities can communicate with the 5GC NF through the second terminal installed with the associated sensing application.

For example, the sensing target without 3GPP terminal capabilities sends the second privacy policy to the core network device through the sensing application of the second terminal. The core network device receives and saves the second privacy policy. In the case of updating the privacy policy, the core network device may receive a new second privacy policy or a second privacy update policy sent by the sensing application of the second terminal. The core network device overwrites the original second privacy policy based on the received new second privacy policy or the second privacy update policy, to update the second privacy policy. It can be understood that the update manner is not limited in the present disclosure.

It can be understood that the present disclosure may configure the privacy policy by using any one or both of the above manners.

The present disclosure provides the privacy policy of the sensing target to the core network device, such that the core network device can determine whether to sense the sensitive information of the sensing target through the privacy policy of the sensing target, thereby effectively protecting the privacy of the sensing target and improving the security of the wireless sensing system.

In the wireless sensing communication method provided in embodiments of the present disclosure, the sensing request at least includes sensing target indication information; the sensing request further includes a sensing request device identifier.

In some embodiments, the sensing request shall at least include the sensing target indication information. It can be understood that the sensing target indication information can be used to indicate the sensing target corresponding to the sensing request.

In some embodiments, the sensing request may further include the sensing request device identifier. It can be understood that the sensing request device identifier can be used to indicate the sensing request device that sends the sensing request. The identifier may be an identity (ID) identifier or an index.

The present disclosure provides a variety of information included in the sensing request, such that the core network device can determine whether to sense the sensitive information of the sensing target through the privacy policy of the sensing target, thereby effectively protecting the privacy of the sensing target and improving the security of the wireless sensing system.

In the wireless sensing communication method provided in embodiments of the present disclosure, the privacy policy includes at least one of the following: a sensing allowlist; a sensing blocklist.

In some embodiments, the privacy policy may include a sensing allowlist. It can be understood that the sensing allowlist may record which devices are allowed to sense the corresponding sensing target. If the sensing request device matches with the information in the sensing allowlist, it means that the sensing request device is allowed to sense the corresponding sensing target and obtain the parameter information of the corresponding sensing target. Matching with the information in the sensing allowlist can be understood as that the sensing request device can be queried in the sensing allowlist.

In some embodiments, the privacy policy may include a sensing blocklist. It can be understood that the sensing blocklist may record which devices are not allowed to sense the corresponding sensing target. If the sensing request device matches with the information in the sensing blocklist, it means that the sensing request device is prohibited from sensing the corresponding sensing target and obtaining the parameter information of the corresponding sensing target. Matching with the information in the sensing blocklist can be understood as that the sensing request device can be queried in the sensing blocklist.

It can be understood that the privacy policy may include a sensing allowlist and a sensing blocklist.

The present disclosure provides a variety of information included in the privacy policy, such that the core network device can determine whether to sense the sensitive information of the sensing target through the privacy policy of the sensing target, thereby effectively protecting the privacy of the sensing target and improving the security of the wireless sensing system.

In the wireless sensing communication method provided by embodiments of the present disclosure, determining the sensing result for the sensing target according to the privacy policy of the sensing target in S13 includes: executing a sensing procedure for the sensing target in response to that the sensing request satisfies the privacy policy of the sensing target, to obtain the sensing result. The sensing result is parameter information of the sensing target.

In some embodiments, in response to that the sensing request satisfies the privacy policy of the sensing target, the core network device can execute the sensing procedure of the sensing target, to obtain the sensing result. It can be understood that, the sensing result at this time is the parameter information of the sensing target.

For example, the core network device determines that the sensing target is allowed to be sensed, and then the sensing procedure of the sensing target can be executed. For example, it involves indicating the sensing of the sensing target by the corresponding instruction, and obtaining the corresponding parameter information obtained by sensing the sensing target by the network device and part of the core network device. In some cases, the core network device can process the obtained parameter information of the sensing target to obtain the sensing result. It can be understood that the processing manner can be possible operations such as deduplication of data, elimination of invalid data, data enhancement, etc. based on the preset rules or the manner specified by the protocol, which can be set according to the actual situation, and the present disclosure does not limit it.

It can be understood that the sensing procedure can be the corresponding sensing procedure in the existing manner, and the present disclosure will not repeat it. The network devices involved in the sensing procedure may be base stations, and the core network devices may be other core network devices, or core network devices that implement the above scheme, which are not limited in this disclosure.

In the case where the privacy policy is satisfied, the present disclosure can determine to sense the sensitive information of the sensing target, thereby effectively protecting the privacy of the sensing target and improving the security of the wireless sensing system.

In the wireless sensing communication method provided in embodiments of the present disclosure, determining a sensing result for the sensing target according to the privacy policy of the sensing target in S13 includes: determining that the sensing result is failure indication information, in response to that the sensing request does not satisfy the privacy policy of the sensing target. The failure indication information is used to indicate failure to acquire parameter information of the sensing target.

In some embodiments, in response to that the sensing request does not satisfy the privacy policy of the sensing target, it is determined that the sensing result is failure indication information. The failure indication information is used to indicate failure to acquire parameter information of the sensing target.

For example, if the core network device determines that the sensing target is prohibited from being sensed, it can generate failure indication information for indicating failure to acquire parameter information of the sensing target. The failure indication information is used as the sensing result, so as to be sent to the sensing request device subsequently.

In the case where the privacy policy is not satisfied, the present disclosure can determine to prohibit the sensing of the sensitive information of the sensing target, thereby effectively protecting the privacy of the sensing target and improving the security of the wireless sensing system.

Based on the same concept, the present disclosure also provides a wireless sensing communication method applied to a sensing request device.

FIG. 3 is a flow chart of a wireless sensing communication method according to another example embodiment. As shown in FIG. 3, the method can be applied to a sensing request device. The sensing request device can be a terminal, an application server, other core network devices, etc. It can be understood that other core network devices and the core network device executing the method of FIG. 2 are different 5GC NFs. The method may include the following steps.

In step S21, a sensing request is sent to the core network device.

In some embodiments, the sensing request device can send a sensing request to the core network device. The sensing request is used to obtain parameter information of the sensing target. Sensing in the present disclosure can also be referred to as perception. The sensing request device can be referred to as a sensing request target or a sensing requestor.

For example, if the sensing requestor wants to obtain parameter information of a sensing target, it can send a sensing request to the core network device, such that the core network device receives the sensing request and learns that the sensing requestor wants to obtain parameter information of the sensing target.

In step S22, the sensing result sent by the core network device is received.

In some embodiments, the sensing request device can receive the sensing result sent by the core network device. The sensing result is determined by the core network device based on the sensing request and in combination with the privacy policy of the sensing target. The privacy policy of the sensing target is pre-configured in the core network device.

For example, when the core network device receives the sensing request sent by the sensing requestor, it may query the pre-configured privacy policy. It can be understood that the core network device may be configured with the privacy policy corresponding to at least one sensing target. The core network device may determine, through the sensing request, the parameter information of which sensing target is requested, then determine the privacy policy corresponding to the sensing target.

The core network device can determine the sensing result of the sensing target according to the privacy policy of the sensing target. The core network device can also determine the sensing result for the sensing target in combination with some protocol regulations or regional regulations.

For example, in some specific places, it is stipulated which sensing targets are allowed to be sensed or prohibited to be sensed. Then the core network device determines the sensing result for the sensing target according to the protocol regulations or regional regulations if the privacy policy of the sensing target is not queried. For another example, if the privacy policy of the sensing target is opposite to the result of the protocol regulations or regional regulations, for example, the privacy policy of the sensing target indicates that the sensing target is allowed to be sensed, while the protocol regulations or regional regulations indicate that the sensing target is prohibited from being sensed; and the privacy policy of the sensing target indicates that the sensing target is prohibited from being sensed, while the protocol regulations or regional regulations indicate that the sensing target is allowed to be sensed, it can be determined whether the sensing target is allowed to be sensed according to preset rules or priorities, which is not limited by this disclosure.

The sensing request device can receive the sensing result obtained and sent by the core network device. It can be understood that the sensing result can be, for example, parameter information of the sensing target, or indication information for indicating prohibition of obtaining sensing information.

The present disclosure determines whether to sense the sensitive information of the sensing target through the privacy policy of the sensing target, thereby effectively protecting the privacy of the sensing target and improving the security of the wireless sensing system.

In the wireless sensing communication method provided by embodiments of the present disclosure, the sensing target includes a first sensing target and/or a second sensing target, the first sensing target is a first terminal or the first sensing target carries the first terminal, and the second sensing target is a non-terminal or the second sensing target does not carry a terminal. The privacy policy of the sensing target is pre-configured in the core network device through at least one of the following manners: configuring and/or updating a first privacy policy based on the first terminal, wherein the first privacy policy is a privacy policy corresponding to the first sensing target; configuring and/or updating a second privacy policy based on a sensing application of a second terminal, wherein the sensing application of the second terminal is associated with the second sensing target, and the second privacy policy is a privacy policy corresponding to the second sensing target.

In some embodiments, the sensing target may include the first sensing target and/or the second sensing target. The first sensing target can be a first terminal, or the first sensing target carries the first terminal. The second sensing target can be a non-terminal, or the second sensing target does not carry a terminal. It can be understood that the non-terminal means that the second sensing target is not a terminal.

The terminal involved in the present disclosure can be considered to have any possible wireless communication capabilities, such as 3GPP terminal capabilities, WIFI communication capabilities, Bluetooth communication capabilities, ZigBee communication capabilities, etc.

In some embodiments, the core network device can configure and/or update the first privacy policy based on the first terminal. The first privacy policy is the privacy policy corresponding to the first sensing target.

It can be understood that, the first sensing target can be a sensing target with 3GPP terminal capabilities. For example, the first sensing target can be a terminal, such as the first terminal. Alternatively, the first sensing target may not have wireless communication capabilities, but the first sensing target can carry a terminal with wireless communication capabilities. For example, the first terminal is configured in the first sensing target. That is, the first sensing target can carry a terminal with 3GPP terminal capabilities, for example, the first sensing target carries the first terminal.

When the first sensing target is the first terminal or the first sensing target carries the first terminal, the core network device configures and/or updates the first privacy policy based on the first terminal.

For example, when the first sensing target is the first terminal or the first sensing target carries the first terminal, the first terminal can communicate directly with the core network device through the wireless communication system, for example, sending the first privacy policy. The core network device can receive and save the first privacy policy. It can be understood that the first privacy policy is used to describe the privacy protection of the first sensing target.

For example, the first terminal sends the first privacy policy to the core network device. The core network device receives and saves the first privacy policy sent by the first terminal. For the case of updating the privacy policy, the core network device can receive a new first privacy policy or a first privacy update policy sent by the first terminal. The core network device overwrites the original first privacy policy based on the received new first privacy policy or the first privacy update policy, to implement the update of the first privacy policy. It can be understood that the update manner is not limited in the present disclosure.

In some embodiments, the second privacy policy is configured and/or updated based on the sensing application of the second terminal. The sensing application of the second terminal is associated with the second sensing target, and the second privacy policy is the privacy policy corresponding to the second sensing target.

It can be understood that the second sensing target may be a sensing target without 3GPP terminal capabilities. For example, some sensing targets may be entities without communication functions, such as buildings, certain specific areas, etc. However, such entities may also be sensed in the wireless sensing scenario. However, these entities may not wish to be sensed due to some special considerations. In some cases, the sensing target without 3GPP terminal capabilities may not carry a terminal with wireless communication capabilities.

The core network device may configure and/or update the second privacy policy based on the sensing application of the second terminal when the second sensing target is a non-terminal or does not carry a terminal.

The sensing application can be installed on the second terminal. That is, the sensing target without 3GPP terminal capabilities can communicate with the 5GC NF through the second terminal installed with the associated sensing application.

For example, the sensing target without 3GPP terminal capabilities sends the second privacy policy to the core network device through the sensing application of the second terminal. The core network device receives and saves the second privacy policy. In the case of updating the privacy policy, the core network device may receive a new second privacy policy or a second privacy update policy sent by the sensing application of the second terminal. The core network device overwrites the original second privacy policy based on the received new second privacy policy or the second privacy update policy, to update the second privacy policy. It can be understood that the update manner is not limited in the present disclosure.

The present disclosure provides the privacy policy of the sensing target to the core network device, such that the core network device can determine whether to sense the sensitive information of the sensing target through the privacy policy of the sensing target, thereby effectively protecting the privacy of the sensing target and improving the security of the wireless sensing system.

In the wireless sensing communication method provided in embodiments of the present disclosure, the sensing request at least includes sensing target indication information; the sensing request further includes a sensing request device identifier.

In some embodiments, the sensing request shall at least include the sensing target indication information. It can be understood that the sensing target indication information can be used to indicate the sensing target corresponding to the sensing request.

In some embodiments, the sensing request may further include the sensing request device identifier. It can be understood that the sensing request device identifier can be used to indicate the sensing request device that sends the sensing request. The identifier may be an identity (ID) identifier or an index.

The present disclosure provides a variety of information included in the sensing request, such that the core network device can determine whether to sense the sensitive information of the sensing target through the privacy policy of the sensing target, thereby effectively protecting the privacy of the sensing target and improving the security of the wireless sensing system.

In the wireless sensing communication method provided in embodiments of the present disclosure, the privacy policy includes at least one of the following: a sensing allowlist; a sensing blocklist.

In some embodiments, the privacy policy may include a sensing allowlist. It can be understood that the sensing allowlist may record which devices are allowed to sense the corresponding sensing target. If the sensing request device matches with the information in the sensing allowlist, it means that the sensing request device is allowed to sense the corresponding sensing target and obtain the parameter information of the corresponding sensing target. Matching with the information in the sensing allowlist can be understood as that the sensing request device can be queried in the sensing allowlist.

In some embodiments, the privacy policy may include a sensing blocklist. It can be understood that the sensing blocklist may record which devices are not allowed to sense the corresponding sensing target. If the sensing request device matches with the information in the sensing blocklist, it means that the sensing request device is prohibited from sensing the corresponding sensing target and obtaining the parameter information of the corresponding sensing target. Matching with the information in the sensing blocklist can be understood as that the sensing request device can be queried in the sensing blocklist.

It can be understood that the privacy policy may include a sensing allowlist and a sensing blocklist.

The present disclosure provides a variety of information included in the privacy policy, such that the core network device can determine whether to sense the sensitive information of the sensing target through the privacy policy of the sensing target, thereby effectively protecting the privacy of the sensing target and improving the security of the wireless sensing system.

In the wireless sensing communication method provided in embodiments of the present disclosure, in response to that the sensing request satisfies the privacy policy of the sensing target, the sensing result is the parameter information of the sensing target. The sensing result is obtained by the core network device executing the sensing procedure of the sensing target.

In some embodiments, in response to that the sensing request satisfies the privacy policy of the sensing target, the sensing result received by the sensing request device is the parameter information of the sensing target. The sensing result is obtained by the core network device executing the sensing procedure of the sensing target.

For example, the core network device determines that the sensing target is allowed to be sensed, and then the sensing procedure of the sensing target can be executed. For example, it involves indicating the sensing of the sensing target by the corresponding instruction, and obtaining the corresponding parameter information obtained by sensing the sensing target by the network device and part of the core network device. In some cases, the core network device can process the obtained parameter information of the sensing target to obtain the sensing result. It can be understood that the processing manner can be possible operations such as deduplication of data, elimination of invalid data, data enhancement, etc. based on the preset rules or the manner specified by the protocol, which can be set according to the actual situation, and the present disclosure does not limit it.

It can be understood that the sensing procedure can be the corresponding sensing procedure in the existing manner, and the present disclosure will not repeat it. The network devices involved in the sensing procedure may be base stations, and the core network devices may be other core network devices, or core network devices that implement the above scheme, which are not limited in this disclosure.

In the case where the privacy policy is satisfied, the present disclosure can determine to sense the sensitive information of the sensing target, thereby effectively protecting the privacy of the sensing target and improving the security of the wireless sensing system.

In the wireless sensing communication method provided by embodiments of the present disclosure, in response to that the sensing request does not satisfy the privacy policy of the sensing target, the sensing result is failure indication information,. The failure indication information is used to indicate failure to acquire parameter information of the sensing target.

In some embodiments, in response to that the sensing request does not satisfy the privacy policy of the sensing target, the sensing result is failure indication information. The failure indication information is used to indicate failure to acquire parameter information of the sensing target.

For example, if the core network device determines that the sensing target is prohibited from being sensed, it can generate failure indication information for indicating failure to acquire parameter information of the sensing target. The failure indication information is used as the sensing result, so as to be sent to the sensing request device subsequently.

In the case where the privacy policy is not satisfied, the present disclosure can determine to prohibit the sensing of the sensitive information of the sensing target, thereby effectively protecting the privacy of the sensing target and improving the security of the wireless sensing system.

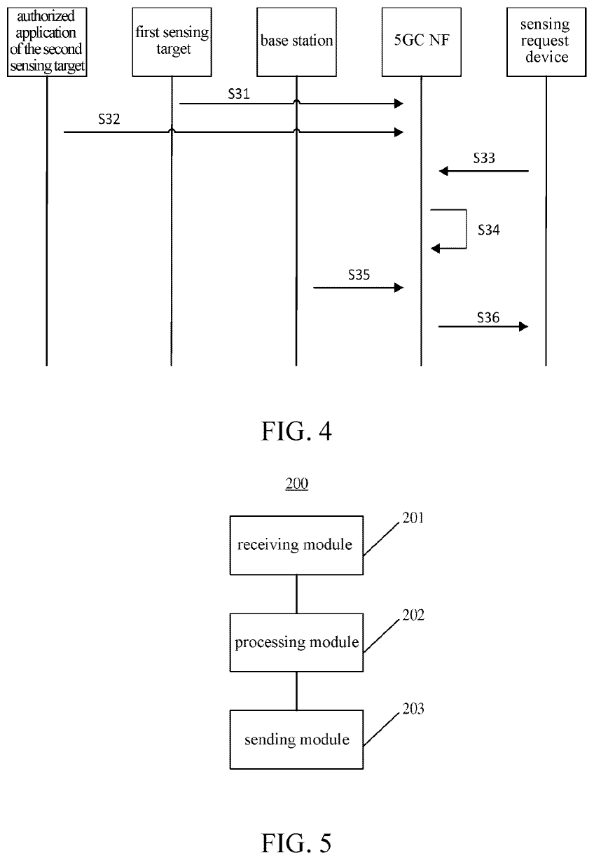

FIG. 4 is a signaling interaction diagram of a wireless sensing communication method according to an example embodiment.

As shown in FIG. 4, the wireless sensing communication method may involve a sensing request device, a core network device, i.e., a 5GC NF, a base station, a first sensing target, and a sensing application of a second sensing target. The first sensing target may be a sensing target with 3GPP terminal capabilities. The second sensing target may be a sensing target without 3GPP terminal capabilities, and therefore, the second sensing target may communicate with the 5GC NF through the sensing application.

The method may include the following steps.

In step S31, the first sensing target configures and/or updates the privacy policy of the first sensing target to the 5GC NF.

For example, for a sensing target with 3GPP terminal capabilities, its own privacy policy may be configured and/or updated to the 5GC.

In step S32, the sensing application of the second sensing target configures and/or updates the privacy policy of the second sensing target to the 5GC NF.

For example, for a sensing target without 3GPP terminal capabilities, that is, the owner or manager of the second sensing target may provide the privacy policy of the second sensing target to the 5GC NF through the sensing application under the control of the network operator.

It can be understood that, the execution of S31 and S32 does not have a strict execution order, for example, S31 may be executed first and then S32, S32 may be executed first and then S31, or S31 and S32 may be executed simultaneously. S31, S32 and S33, S34, S35 and S36 do not have a strict execution order either. For example, S31 and/or S32 can be executed before, during or after any step of S33, S34, S35 and S36. In other words, S31 and/or S32 can be executed at any time, and the present disclosure does not limit it.

In step S33, the sensing request device sends a sensing request to the 5GC NF.

For example, the sensing request can at least include the sensing target indication information. For another example, the sensing request can also include the sensing request device ID.

In step S34, the 5GC NF performs the privacy detection.

For example, the 5GC NF can perform the privacy check based on the privacy policy configured by the sensing application of the second sensing target or the first sensing target, as well as relevant regional and national regulations.

It can be understood that if the sensing target is allowed to be sensed, S35 is executed. If the sensing target is prohibited from being sensed, it can be directly determined that the sensing result is failure indication information, and S36 is executed.

In step S35, 5GC NF and/or base station execute the sensing procedure, to obtain the sensing result.

For example, if the sensing target is allowed to be sensed, the 5GC NF and/or base station may execute the sensing program, to obtain the parameter information of the sensing target, and the parameter information of the sensing target is used as the sensing result.

In step S36, 5GC NF sends the sensing result to the sensing request device.

It can be understood that the specific implementation of each step in FIG. 4 can refer to the description of the corresponding embodiments in FIGS. 2 and 3, and the present disclosure will not repeat it here.

It should be noted that those skilled in the art can understand that the various implementations/embodiments involved in the above-mentioned embodiments of the present disclosure can be used in conjunction with the aforementioned embodiments or can be used independently. Whether used alone or in conjunction with the aforementioned embodiments, the implementation principle is similar. In the implementation of the present disclosure, some embodiments are illustrated in a manner where they are used together. Those skilled in the art can understand that such illustrative examples are not intended to limit the embodiments of this disclosure.

Based on the same concept, the embodiments of the present disclosure also provide a wireless sensing communication apparatus and device.

It can be understood that the wireless sensing communication apparatus and device provided by embodiments of the present disclosure include corresponding hardware structures and/or software modules for executing each function, in order to realize the above functions. In combination with the units and algorithm steps of each example disclosed in the embodiments of the present disclosure, the embodiments of the present disclosure can be implemented in the form of hardware or a combination of hardware and computer software. Whether a function is executed in the form of hardware or computer software driving hardware depends on the specific application and design constraints of the technical solution. Those skilled in the art can use different methods for each specific application to implement the described functions, but such implementation should not be considered to exceed the scope of the technical solution of embodiments of the present disclosure.

FIG. 5 is a schematic diagram of a wireless sensing communication apparatus according to an example embodiment. Referring to FIG. 5, the apparatus 200 is configured in a core network device, and the apparatus 200 includes: a receiving module 201, configured to receive a sensing request sent by a sensing request device, wherein the sensing request is used to acquire parameter information of a sensing target; a processing module 202, configured to determine a privacy policy of the sensing target corresponding to the sensing request based on the sensing request, wherein the privacy policy of the sensing target is pre-configured in the core network device; wherein the processing module 202 is further configured to determine a sensing result for the sensing target according to the privacy policy of the sensing target; a sending module 203, configured to send the sensing result to the sensing request device.

The present disclosure determines whether to sense the sensitive information of the sensing target through the privacy policy of the sensing target, thereby effectively protecting the privacy of the sensing target and improving the security of the wireless sensing system.

In some implementations, the sensing target includes a first sensing target and/or a second sensing target, the first sensing target is a first terminal or the first sensing target carries the first terminal, and the second sensing target is a non-terminal or the second sensing target does not carry a terminal; the privacy policy of the sensing target is pre-configured in the core network device through at least one of the following manners: configuring and/or updating a first privacy policy based on the first terminal, wherein the first privacy policy is a privacy policy corresponding to the first sensing target; configuring and/or updating a second privacy policy based on a sensing application of a second terminal, wherein the sensing application of the second terminal is associated with the second sensing target, and the second privacy policy is a privacy policy corresponding to the second sensing target.

The present disclosure provides the privacy policy of the sensing target to the core network device, such that the core network device can determine whether to sense the sensitive information of the sensing target through the privacy policy of the sensing target, thereby effectively protecting the privacy of the sensing target and improving the security of the wireless sensing system.

In some implementations, the sensing request at least includes sensing target indication information; the sensing request further includes a sensing request device identifier.

The present disclosure provides a variety of information included in the sensing request, such that the core network device can determine whether to sense the sensitive information of the sensing target through the privacy policy of the sensing target, thereby effectively protecting the privacy of the sensing target and improving the security of the wireless sensing system.

In some implementations, the privacy policy includes at least one of the following: a sensing allowlist; a sensing blocklist.

The present disclosure provides a variety of information included in the privacy policy, such that the core network device can determine whether to sense the sensitive information of the sensing target through the privacy policy of the sensing target, thereby effectively protecting the privacy of the sensing target and improving the security of the wireless sensing system.

In some implementations, the processing module 202 is further configured to: execute a sensing procedure for the sensing target in response to that the sensing request satisfies the privacy policy of the sensing target, to obtain the sensing result, wherein the sensing result is parameter information of the sensing target.

In the case where the privacy policy is satisfied, the present disclosure can determine to sense the sensitive information of the sensing target, thereby effectively protecting the privacy of the sensing target and improving the security of the wireless sensing system.

In some implementations, the processing module 202 is further configured to: the sensing result is failure indication information, in response to that the sensing request does not satisfy the privacy policy of the sensing target, wherein the failure indication information is used to indicate failure to acquire parameter information of the sensing target.

In the case where the privacy policy is not satisfied, the present disclosure can determine to prohibit the sensing of the sensitive information of the sensing target, thereby effectively protecting the privacy of the sensing target and improving the security of the wireless sensing system.

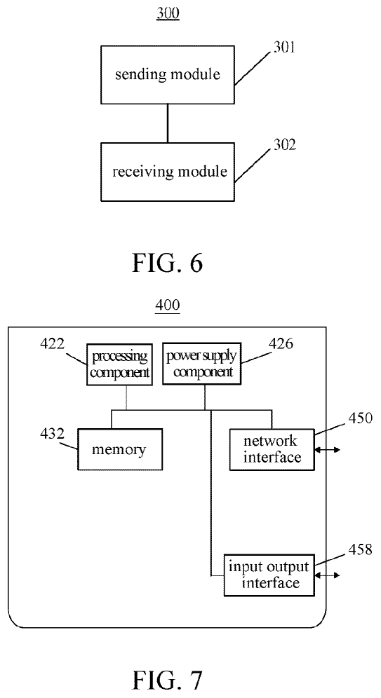

FIG. 6 is a schematic diagram of a wireless sensing communication apparatus according to another example embodiment. Referring to FIG. 6, the apparatus 300 is configured in the sensing request device, and the apparatus 300 includes: a sending module 301, configured to send a sensing request to a core network device, wherein the sensing request is used to acquire parameter information of a sensing target; a receiving module 302, configured to receive a sensing result sent by the core network device, wherein the core network device determines the sensing result based on the sensing request and in combination with a privacy policy of the sensing target, and the privacy policy of the sensing target is pre-configured in the core network device.

The present disclosure determines whether to sense the sensitive information of the sensing target based on the privacy policy of the sensing target, thereby effectively protecting the target's privacy and enhancing the security of the wireless sensing system.

In some implementations, the sensing target includes a first sensing target and/or a second sensing target, the first sensing target is a first terminal or the first sensing target carries the first terminal, and the second sensing target is a non-terminal or the second sensing target does not carry a terminal; the privacy policy of the sensing target is pre-configured in the core network device through at least one of the following manners: configuring and/or updating a first privacy policy based on the first terminal, wherein the first privacy policy is a privacy policy corresponding to the first sensing target; configuring and/or updating a second privacy policy based on a sensing application of a second terminal, wherein the sensing application of the second terminal is associated with the second sensing target, and the second privacy policy is a privacy policy corresponding to the second sensing target.

The present disclosure provides the privacy policy of the sensing target to the core network device, such that the core network device can determine whether to sense the sensitive information of the sensing target through the privacy policy of the sensing target, thereby effectively protecting the privacy of the sensing target and improving the security of the wireless sensing system.

In some implementations, the sensing request at least includes sensing target indication information; the sensing request further includes a sensing request device identifier.

The present disclosure provides a variety of information included in the sensing request, such that the core network device can determine whether to sense the sensitive information of the sensing target through the privacy policy of the sensing target, thereby effectively protecting the privacy of the sensing target and improving the security of the wireless sensing system.

In some implementations, the privacy policy includes at least one of the following: a sensing allowlist; a sensing blocklist.

The present disclosure provides a variety of information included in the privacy policy, such that the core network device can determine whether to sense the sensitive information of the sensing target through the privacy policy of the sensing target, thereby effectively protecting the privacy of the sensing target and improving the security of the wireless sensing system.

In some implementations, the sensing result is parameter information of the sensing target, in response to that the sensing request satisfies the privacy policy of the sensing target, wherein the sensing result is obtained by the core network device executing a sensing procedure for the sensing target.

The present disclosure can determine to sense the sensitive information of the sensing target when the privacy policy is satisfied, thereby effectively protecting the privacy of the sensing target and improving the security of the wireless sensing system.

In some implementations, the sensing result is failure indication information, in response to which the sensing request does not satisfy the privacy policy of the sensing target. The failure indication information is used to indicate failure to acquire parameter information of the sensing target.

In cases where the privacy policy is not satisfied, the present disclosure can determine to prohibit the sensing of sensitive information of the sensing target, thereby effectively protecting the privacy of the sensing target and improving the security of the wireless sensing system.

Regarding the apparatus in the above embodiment, the specific manner in which each module performs the operation has been described in detail in the embodiment of the method, and will not be elaborated here.

FIG. 7 is a schematic diagram of a wireless sensing communication device according to an example embodiment. For example, the device 400 can be provided as a base station, or a server or a core network device. For example, the device 400 can be the core network device mentioned above, or other core network devices, application servers, etc. as a sensing request device. Referring to FIG. 7, the device 400 includes a processing component 422, which further includes one or more processors, and memory resources represented by a memory 432, for storing instructions executable by the processing component 422, such as an application. The application stored in the memory 432 may include one or more modules each corresponding to a set of instructions. In addition, the processing component 422 is configured to execute instructions to execute the above methods.

The device 400 may also include a power supply component 426 configured to perform power management of the device 400, a wired or wireless network interface 450 configured to connect the device 400 to a network, and an input/output (I/O) interface 458. The device 400 may operate based on an operating system stored in the memory 432, such as Windows Server™, Mac OS X™, Unix™, Linux™, FreeBSD™ or the like.

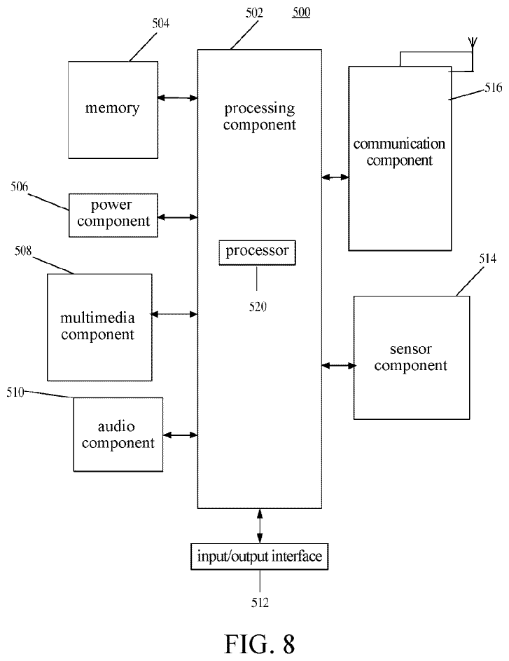

FIG. 8 is a schematic diagram of a wireless sensing communication device according to another example embodiment. For example, the device 500 may be any terminal such as a mobile phone, a computer, a digital broadcast terminal, a messaging device, a game console, a tablet device, a medical device, a fitness device, a personal digital assistant, etc.

It is understood that the device 500 may be the terminal, the first terminal and/or the second terminal mentioned above as a sensing request device.

Referring to FIG. 8, the device 500 may include at least one or more of the following components: a processing component 502, a memory 504, a power component 506, a multimedia component 508, an audio component 510, an input/output (I/O) interface 512, a sensor component 514, and a communication component 516.

The processing component 502 typically controls the overall operations of the device 500, such as the operations associated with display, telephone calls, data communications, camera operations, and recording operations. The processing component 502 can include one or more processors 520 to execute instructions to perform all or part of the steps in the above described methods. Moreover, the processing component 502 can include one or more modules to facilitate the interaction between the processing component 502 and other components. For example, the processing component 502 can include a multimedia module to facilitate the interaction between the multimedia component 508 and the processing component 502.

The memory 504 is configured to store various types of data to support the operation of the device 500. Examples of such data include instructions for any application or method operated on the device 500, the contact data, the phone book data, messages, pictures, videos, and the like. The memory 504 can be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the device 500. The power component 506 can include a power management system, one or more power sources, and other components associated with the generation, management, and distribution of power for the device 500.

The multimedia component 508 includes a screen providing an output interface between the device 500 and the user. In some embodiments, the screen can include a liquid crystal display (LCD) and a touch panel (TP). If the screen includes the touch panel, the screen can be implemented as a touch screen to receive input signals from the user. The touch panel includes one or more touch sensors to sense touches, swipes, and gestures on the touch panel. The touch sensors may not only sense a boundary of a touch or swipe action, but also detect the duration time and pressure associated with the touch or swipe action. In some embodiments, the multimedia component 508 includes a front camera and/or a rear camera. When the device 500 is in an operation mode, such as a photographing mode or a video mode, the front camera and/or the rear camera can receive external multimedia data. Each of the front camera and the rear camera may be a fixed optical lens system or have focus and optical zoom capability.

The audio component 510 is configured to output and/or input an audio signal. For example, the audio component 510 includes a microphone (MIC) configured to receive an external audio signal when the device 500 is in an operation mode, such as a call mode, a recording mode, and a voice recognition mode. The received audio signal may be further stored in the memory 504 or sent via the communication component 516. In some embodiments, the audio component 510 also includes a speaker for outputting the audio signal.

The I/O interface 512 provides an interface between the processing component 502 and peripheral interface modules, such as keyboards, a click wheels, buttons, and the like. These buttons may include, but not limited to, a home button, a volume button, a starting button, and a locking button.

The sensor component 514 includes one or more sensors for providing state assessments of various aspects of the device 500. For example, the sensor component 514 can detect an open/closed state of the device 800, relative positioning of components, such as the display and the keypad of the device 500. The sensor component 514 can also detect a change in position of one component of the device 500 or the device 500, the presence or absence of user contact with the device 500, an orientation, or an acceleration/deceleration of the device 500, and a change in temperature of the device 500. The sensor component 514 can also include a proximity sensor configured to detect the presence of nearby objects without any physical contact. The sensor component 514 can also include a light sensor, such as a CMOS or CCD image sensor, configured to use in imaging applications. In some embodiments, the sensor component 514 can also include an accelerometer sensor, a gyroscope sensor, a magnetic sensor, a pressure sensor, or a temperature sensor.

The communication component 516 is configured to facilitate wired or wireless communication between the device 500 and other devices. The device 500 can access a wireless network based on a communication standard, such as WiFi, 2G, 3G, or a combination thereof. In an example embodiment, the communication component 516 receives broadcast signals or broadcast associated information from an external broadcast management system via a broadcast channel. In an example embodiment, the communication component 516 also includes a near field communication (NFC) module to facilitate short-range communications. For example, the NFC module can be implemented based on radio frequency identification (RFID) technology, infrared data association (IrDA) technology, ultra-wideband (UWB) technology, Bluetooth (BT) technology and other technologies.

In an example embodiment, the device 500 may be implemented with one or more application specific integrated circuits (ASIC), digital signal processors (DSP), digital signal processing devices (DSPD), programmable logic devices (PLD), field programmable Gate arrays (FPGA), controllers, microcontrollers, microprocessors or other electronic components, to perform the above methods.

In an example embodiment, a non-transitory computer-readable storage medium including instructions is also provided, such as a memory 504 including instructions, and the above instructions can be executed by the processor 520 of the device 500 to complete the above method. For example, the non-transitory computer-readable storage medium can be a ROM, a random access memory (RAM), a CD-ROM, a magnetic tape, a floppy disk, and an optical data storage device.

When receiving a sensing request for a sensing target, the 5GC will perform the privacy check to ensure that the sensing target is allowed to be sensed. If the sensing target is allowed to be sensed, the sensing procedure of the sensing target is executed. The sensing result will be sent to the sensing request device, thereby protecting the privacy of the sensing target.

It can be further understood that in the present disclosure, “a plurality of” refers to two or more, and other quantifiers are similar. “And/or” describes the association relationship of associated objects, indicating that three relationships can exist. For example, A and/or B can represent: A exists alone, A and B exist at the same time, and B exists alone. The character “/” generally indicates that the previous and subsequent associated objects are in an “or” relationship. The singular forms of “a”, “the” and “said” are also intended to include plural forms unless the context clearly indicates other meanings.

It can be further understood that, the terms “first”, “second”, etc. are used to describe various information, but these information should not be limited to these terms. These terms are only used to distinguish the same type of information from each other, and do not indicate a specific order or degree of importance. In fact, the expressions of “first”, “second”, etc. can be used interchangeably. For example, without departing from the scope of the present disclosure, the first information may also be referred to as the second information, and similarly, the second information may also be referred to as the first information.

It is further understood that, the meaning of the words “in response to” and “if” involved in the present disclosure depends on the context and the actual use scenario, such as the word “in response to” used herein may be interpreted as “at . . . ” or “when . . . ” or “if” or “in a case that”.

It is further understood that, although the operations are described in a specific order in the drawings in the embodiments of the present disclosure, it should not be understood as requiring the operations to be performed in the specific order shown or in a serial order, or requiring the execution of all the operations shown to obtain the desired results. In certain environments, multitasking and parallel processing may be advantageous.

Other embodiments of the present disclosure will easily occur to those skilled in the art after considering the specification and practicing the disclosure disclosed herein. The present application is intended to cover any variation, use or adaptation of the present disclosure, which follows the general principles of the present disclosure and includes common sense or common technical means in the technical field not disclosed in this disclosure.

It should be understood that the present disclosure is not limited to the precise structure described above and shown in the drawings, and various modifications and changes can be made without departing from its scope. The scope of the present disclosure is limited only by the appended claims.

1. A method for wireless sensing communication, performed by a core network device, the method comprising:
receiving a sensing request sent by a sensing request device, wherein the sensing request is used to acquire parameter information of a sensing target;
determining a privacy policy of the sensing target corresponding to the sensing request based on the sensing request, wherein the privacy policy of the sensing target is pre-configured in the core network device;
determining a sensing result for the sensing target according to the privacy policy of the sensing target; and
sending the sensing result to the sensing request device.

2. The method according to claim 1, wherein the sensing target comprises at least one of a first sensing target or a second sensing target, the first sensing target is a first terminal or the first sensing target carries the first terminal, and the second sensing target is a non-terminal or the second sensing target does not carry a terminal;
the privacy policy of the sensing target is pre-configured in the core network device through at least one of following:
configuring and/or updating a first privacy policy based on the first terminal, wherein the first privacy policy is a privacy policy corresponding to the first sensing target;
configuring and/or updating a second privacy policy based on a sensing application of a second terminal, wherein the sensing application of the second terminal is associated with the second sensing target, and the second privacy policy is a privacy policy corresponding to the second sensing target.

3. The method according to claim 1, wherein the sensing request at least comprises sensing target indication information.

4. The method according to claim 1, wherein the privacy policy comprises at least one of following:
a sensing allowlist; or
a sensing blocklist.

5. The method according to claim 1, wherein determining the sensing result for the sensing target according to the privacy policy of the sensing target comprises:
executing a sensing procedure for the sensing target in response to that the sensing request satisfies the privacy policy of the sensing target, to obtain the sensing result, wherein the sensing result is parameter information of the sensing target.

6. The method according to claim 1, wherein determining the sensing result for the sensing target according to the privacy policy of the sensing target comprises:
determining that the sensing result is failure indication information in response to that the sensing request does not satisfy the privacy policy of the sensing target, wherein the failure indication information is used to indicate failure to acquire parameter information of the sensing target.

7. A method for wireless sensing communication, performed by a sensing request device, the method comprising:
sending a sensing request to a core network device, wherein the sensing request is used to acquire parameter information of a sensing target; and
receiving a sensing result sent by the core network device, wherein the sensing result is determined by the core network device based on the sensing request and in combination with a privacy policy of the sensing target, and the privacy policy of the sensing target is pre-configured in the core network device.

8. The method according to claim 7, wherein the sensing target comprises at least one of a first sensing target or a second sensing target, the first sensing target is a first terminal or the first sensing target carries the first terminal, and the second sensing target is a non-terminal or the second sensing target does not carry a terminal;
the privacy policy of the sensing target is pre-configured in the core network device through at least one of following:
configuring and/or updating a first privacy policy based on the first terminal, wherein the first privacy policy is a privacy policy corresponding to the first sensing target;
configuring and/or updating a second privacy policy based on a sensing application of a second terminal, wherein the sensing application of the second terminal is associated with the second sensing target, and the second privacy policy is a privacy policy corresponding to the second sensing target.

9. The method according to claim 7, wherein the sensing request at least comprises sensing target indication information.

10. The method according to claim 7, wherein the privacy policy comprises at least one of following:
a sensing allowlist; or
a sensing blocklist.

11. The method according to claim 7, wherein the sensing result is parameter information of the sensing target in response to that the sensing request satisfies the privacy policy of the sensing target, wherein the sensing result is obtained by the core network device executing a sensing procedure for the sensing target.

12. The method according to claim 7, wherein the sensing result is failure indication information in response to that the sensing request does not satisfy the privacy policy of the sensing target, wherein the failure indication information is used to indicate failure to acquire parameter information of the sensing target.

13.-14. (canceled)

15. A wireless sensing communication device, comprising:
a processor;
a memory for storing processor executable instructions;
wherein the processor is configured to:
receive a sensing request sent by a sensing request device, wherein the sensing request is used to acquire parameter information of a sensing target;
determine a privacy policy of the sensing target corresponding to the sensing request based on the sensing request, wherein the privacy policy of the sensing target is pre-configured in a core network device;
determine a sensing result for the sensing target according to the privacy policy of the sensing target; and
send the sensing result to the sensing request device.

16. A wireless sensing communication device, comprising:
a processor;
a memory for storing processor executable instructions;
wherein the processor executable instructions when executed by the processor cause the wireless sensing communication device to act as the sensing request device and perform the method according to claim 7.

17. A non-transitory computer-readable storage medium that stores instructions, the instructions when executed by a processor of the core network device, cause the core network device to perform the method according to claim 1.

18. A non-transitory computer-readable storage medium that stores instructions, the instructions when executed by a processor of the sensing request device, cause the sensing request device to perform the method according to claim 7.

19. The method according to claim 1, wherein the sensing request further comprises a sensing request device identifier.

20. The method according to claim 7, wherein the sensing request further comprises a sensing request device identifier.
